(19) United States
(12) Patent Application Publication
(10) Pub. No.: US 2020/0241646 A1
(43) Pub. Date: Jul. 30, 2020

(54) ON-DEVICE CLASSIFICATION OF FINGERTIP MOTION PATTERNS INTO GESTURES IN REAL-TIME

(71) Applicant: Tata Consultancy Services Limited, Mumbai (IN)

(72) Inventors: Ramya Sugnana Murthy HEBBALAGUPPE, Gurgaon (IN); Varun JAIN, Gurgaon (IN); Gaurav GARG, Gurgaon (IN)

(73) Assignee: Tata Consultancy Services Limited, Mumbai (IN)

(21) Appl. No.: 16/591,299

(22) Filed: Oct. 2, 2019

(30) Foreign Application Priority Data
Jan. 25, 2019 (IN) 201921003256

(51) Int. Cl. G06F 3/01; G06F 17/18; G06K 9/62; G06N 20/00; G06T 3/40; G06T 19/00

(52) U.S. Cl. CPC G06F 3/017; G06F 3/011; G06F 17/18; G06T 19/006; G06N 20/00; G06T 3/40; G06K 9/6267

(57) ABSTRACT

Hand gestures form an intuitive means of interaction in Augmented Reality/Mixed Reality (MR) applications. However, accurate gesture recognition can be achieved through deep learning models or with use of expensive sensors. Despite the robustness of these deep learning models, they are generally computationally expensive and obtaining real-time performance remains a challenge. Embodiments of the present disclosure provide systems and methods for classifying fingertip motion patterns into different hand gestures. Red Green Blue (RGB) images are fed as input to an object detector (MobileNetV2) for outputting hand candidate bounding box, which are then down-scaled to reduce processing time without compromising on the quality of image features. Detected hand candidates are then fed to a fingertip regressor which outputs spatial location of fingertip representing motion pattern wherein coordinates of the fingertip are fed to a Bi-Long Short Term Memory network for classifying the motion pattern into different gestures.

### PRIORITY CLAIM

This U.S. patent application claims priority under 35 U.S.C. § 119 to: India Application No. 201921003256, filed on Jan. 25, 2019. The entire contents of the aforementioned application are incorporated herein by reference.

### TECHNICAL FIELD

The disclosure herein generally relates to classification techniques, and, more particularly, to on-device classification of fingertip motion patterns into gestures in real-time.

### BACKGROUND

Over the past few decades, information technology has transitioned from desktop to mobile computing. Smartphones, tablets, smart watches and Head Mounted Devices (HMDs) are (or have) slowly replacing (or replaced) the desktop based computing. There has been a clear shift in terms of computing from office and home-office environments to an anytime-anywhere activity. Mobile phones form a huge part of lives: the percentage of traffic on the internet generated from them is overtaking its desktop counterparts. Naturally, with this transition, the way humans interact with these devices also has evolved from keyboard/mice to gestures, speech and brain computer interfaces. In a noisy outdoor setup, speech interfaces tend to be less accurate, and as a result the combination of hand gestural interface and speech are of interest to most HCl researchers. Hand gesture recognition on a real-time feed or a video is a form of activity recognition. Hand gestures form an intuitive means of interaction in Mixed Reality (MR) applications. However, accurate gesture recognition can be achieved only through deep learning models or with the use of expensive sensors. Despite the robustness of these deep learning models, they are generally computationally expensive and obtaining real-time performance is still a challenge.

### SUMMARY

Embodiments of the present disclosure present technological improvements as solutions to one or more of the above-mentioned technical problems recognized by the inventors in conventional systems. For example, in one aspect, a processor implemented method for an on-device classification of fingertip motion patterns into gestures in real-time. The method comprises receiving in real-time, in a Cascaded Deep Learning Model (CDLM) executed via the one or more hardware processors of a mobile communication device, a plurality of Red, Green and Blue (RGB) input images from an image capturing device, wherein each of the plurality of RGB input images comprises a hand gesture; detecting in real-time, using an object detector comprised in the Cascaded Deep Learning Model (CDLM) executed via the one or more hardware processors on the mobile communication device, a plurality of hand candidate bounding boxes from the received plurality of RGB input images, wherein each of the plurality of hand candidate bounding boxes is specific to a corresponding RGB image from the received plurality of RGB input images, wherein each of the plurality of hand candidate bounding boxes comprises a hand candidate; downscaling in real-time, the hand candidate from each of the plurality of hand candidate bounding boxes to obtain a set of down-scaled hand candidates; detecting in real-time, using a Fingertip regressor comprised in the Cascaded Deep Learning Model (CDLM) executed via the one or more hardware processors on the mobile communication device, a spatial location of a fingertip from each down-scaled hand candidate from the set of down-scaled hand candidates, wherein the spatial location of the fingertip from the set of down-scaled hand candidates represents a fingertip motion pattern; and classifying in real-time, via a Bidirectional Long Short Term Memory (Bi-LSTM) Network comprised in the Cascaded Deep Learning Model (CDLM) executed via the one or more hardware processors on the mobile communication device, using a first coordinate and a second coordinate from the spatial location of the fingertip, the fingertip motion pattern into one or more hand gestures.

In an embodiment, each of the hand candidate bounding boxes comprising the hand candidate depicts a pointing gesture pose to be utilized for classifying into the one or more hand gestures.

In an embodiment, the step of classifying the fingertip motion pattern into one or more hand gestures comprises applying a regression technique on the first coordinate and the second coordinate of the fingertip.

In an embodiment, the spatial location of the fingertip is detected based on a presence of a positive pointing-finger hand detection on a set of consecutive frames in the plurality of RGB input images, and wherein the presence of the positive pointing-finger hand detection is indicative of a start of the hand gesture.

In an embodiment, an absence of a positive pointing-finger hand detection on a set of consecutive frames in the plurality of RGB input images is indicative of an end of the hand gesture.

In another aspect, there is provided a system for classification of fingertip motion patterns into gestures in real-time. The system comprises a memory storing instructions; one or more communication interfaces; and one or more hardware processors coupled to the memory via the one or more communication interfaces, wherein the one or more hardware processors are configured by the instructions to: receive in real-time, in a Cascaded Deep Learning Model (CDLM) comprised in the memory and executed via the one or more hardware processors of the system, a plurality of Red, Green and Blue (RGB) input images from an image capturing device, wherein each of the plurality of RGB input images comprises a hand gesture; detect in real-time, using an object detector comprised in the Cascaded Deep Learning Model (CDLM) executed via the one or more hardware processors on the system, a plurality of hand candidate bounding boxes from the received plurality of RGB input images, wherein each of the plurality of hand candidate bounding boxes is specific to a corresponding RGB image from the received plurality of RGB input images, wherein each of the plurality of hand candidate bounding boxes comprises a hand candidate; downscaling in real-time, the hand candidate from each of the plurality of hand candidate bounding boxes to obtain a set of down-scaled hand candidates; detecting in real-time, using a Fingertip regressor comprised in the Cascaded Deep Learning Model (CDLM) executed via the one or more hardware processors on the system, a spatial location of a fingertip from each down-scaled hand candidate from the set of down-scaled hand candidates, wherein the spatial location of the fingertip from the set of down-scaled hand candidates represents a fingertip motion pattern; and classifying in real-time, via a Bidirectional Long Short Term Memory (Bi-LSTM) Network comprised in the Cascaded Deep Learning Model (CDLM) executed via the one or more hardware processors on the system, using a first coordinate and a second coordinate from the spatial location of the fingertip, the fingertip motion pattern into one or more hand gestures.

In an embodiment, each of the hand candidate bounding boxes comprising the hand candidate depicts a pointing gesture pose to be utilized for classifying into the one or more hand gestures.

In an embodiment, the fingertip motion pattern is classified into one or more hand gestures by applying a regression technique on the first coordinate and the second coordinate of the fingertip.

In an embodiment, the spatial location of the fingertip is detected based on a presence of a positive pointing-finger hand detection on a set of consecutive frames in the plurality of RGB input images, and wherein the presence of the positive pointing-finger hand detection is indicative of a start of the hand gesture.

In an embodiment, an absence of a positive pointing-finger hand detection on a set of consecutive frames in the plurality of RGB input images is indicative of an end of the hand gesture.

In yet another aspect, there are provided one or more non-transitory machine readable information storage mediums comprising one or more instructions which when executed by one or more hardware processors cause receiving in real-time, in a Cascaded Deep Learning Model (CDLM) executed via the one or more hardware processors of a mobile communication device, a plurality of Red, Green and Blue (RGB) input images from an image capturing device, wherein each of the plurality of RGB input images comprises a hand gesture; detecting in real-time, using an object detector comprised in the Cascaded Deep Learning Model (CDLM) executed via the one or more hardware processors on the mobile communication device, a plurality of hand candidate bounding boxes from the received plurality of RGB input images, wherein each of the plurality of hand candidate bounding boxes is specific to a corresponding RGB image from the received plurality of RGB input images, wherein each of the plurality of hand candidate bounding boxes comprises a hand candidate; downscaling in real-time, the hand candidate from each of the plurality of hand candidate bounding boxes to obtain a set of down-scaled hand candidates; detecting in real-time, using a Fingertip regressor comprised in the Cascaded Deep Learning Model (CDLM) executed via the one or more hardware processors on the mobile communication device, a spatial location of a fingertip from each down-scaled hand candidate from the set of down-scaled hand candidates, wherein the spatial location of the fingertip from the set of down-scaled hand candidates represents a fingertip motion pattern; and classifying in real-time, via a Bidirectional Long Short Term Memory (Bi-LSTM) Network comprised in the Cascaded Deep Learning Model (CDLM) executed via the one or more hardware processors on the mobile communication device, using a first coordinate and a second coordinate from the spatial location of the fingertip, the fingertip motion pattern into one or more hand gestures.

In an embodiment, each of the hand candidate bounding boxes comprising the hand candidate depicts a pointing gesture pose to be utilized for classifying into the one or more hand gestures.

In an embodiment, the step of classifying the fingertip motion pattern into one or more hand gestures comprises applying a regression technique on the first coordinate and the second coordinate of the fingertip.

In an embodiment, the spatial location of the fingertip is detected based on a presence of a positive pointing-finger hand detection on a set of consecutive frames in the plurality of RGB input images, and wherein the presence of the positive pointing-finger hand detection is indicative of a start of the hand gesture.

In an embodiment, an absence of a positive pointing-finger hand detection on a set of consecutive frames in the plurality of RGB input images is indicative of an end of the hand gesture.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates an exemplary block diagram of a system for on-device classification of fingertip motion patterns into gestures in real-time, in accordance with an embodiment of the present disclosure.

FIG. 2 illustrates an exemplary block diagram of the system for on-device classification of fingertip motion patterns into gestures in real-time, in accordance with an embodiment of the present disclosure, in accordance with an embodiment of the present disclosure.

FIG. 3 illustrates an exemplary flow diagram of a method for on-device classification of fingertip motion patterns into gestures in real-time using the system of FIG. 1 in accordance with an embodiment of the present disclosure.

FIG. 4 depicts a fingertip regressor architecture for fingertip localization as implemented by the system of FIG. 1, in accordance with an example embodiment of the present disclosure.

FIG. 5 depicts gesture sequences shown to users before data collection, in accordance with an example embodiment of the present disclosure.

FIG. 6 depicts image comparison of present disclosure versus conventional approaches that indicate results of detectors (hand candidate bounding boxes) in different conditions such as poor illumination, blurry rendering, indoor and outdoor environments respectively, in accordance with an example embodiment of the present disclosure.

FIGS. 7A-7B illustrate a graphical representations depicting comparison of finger localization of the present disclosure versus with conventional technique(s), in accordance with an example embodiment of the present disclosure.

FIG. 8 depicts an overall performance of the method of FIG. 3 on 240 egocentric videos captured using a smartphone based Google® Cardboard head-mounted device, in accordance with an example embodiment of the present disclosure.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the scope of the disclosed embodiments. It is intended that the following detailed description be considered as exemplary only, with the true scope being indicated by the following claims.

Expensive Augmented Reality (AR)/Mixed Reality (MR) devices such as the Microsoft® HoloLens, Daqri and Meta Glasses provide a rich user interface by using recent hardware advancements. They are equipped with a variety of on-board sensors including multiple cameras, a depth sensor and proprietary processor(s). This makes them expensive and unaffordable for mass adoption.

In order to provide a user friendly interface via hand gestures, detecting hands in the user's Field of View (FoV), localising (or localizing) certain keypoints on the hand, and understanding their motion pattern has been of importance to the vision community in recent times. Despite having robust deep learning models to solve such problems using state-of-the art object detectors and sequence tracking methodologies, obtaining real-time performance, particularly, on systems, for example, an on-device, is still a challenge owing to resource constraints on memory and processing.

In the present disclosure, embodiments describe a computationally effective hand gesture recognition framework that works without depth information and the need of specialized hardware, thereby providing mass accessibility of gestural interfaces to the most affordable video see-through HMDs. These devices provide Virtual Reality (VR)/MR experiences by using stereo rendering of the smartphone camera feed but have limited user interaction capabilities.

Industrial inspection and repair, tele-presence, and data visualization are some of the immediate applications for the framework described by the embodiments of the present disclosure and which can work in real-time and has the benefit of being able to work in remote environments without the need of internet connectivity. To demonstrate the generic nature of the framework implemented in the present disclosure, detection of 10 complex gestures were performed using the pointing hand pose has been demonstrated with a sample Android application.

To this end, embodiments of the present disclosure provide systems and methods that implement hand gesture recognition framework that works in First Person View for wearable devices. The models are trained on a Graphics Processing Unit (GPU) machine and ported on an Android smartphone for its use with frugal wearable devices such as the Google® Cardboard and VR Box. The present disclosure implements hand gesture recognition framework that is driven by cascade deep learning models: MobileNetV2 for hand localisation (or localization), a fingertip regression architecture followed by a Bi-LSTM model for gesture classification.

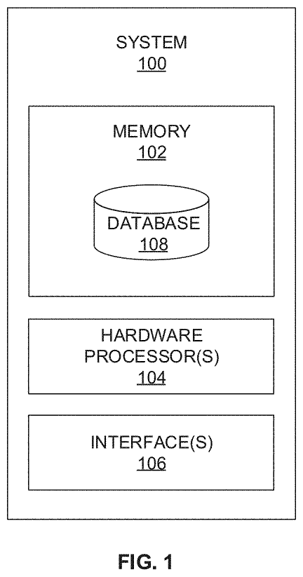

Referring now to the drawings, and more particularly to FIGS. 1 through 8, where similar reference characters denote corresponding features consistently throughout the figures, there are shown preferred embodiments and these embodiments are described in the context of the following exemplary system and/or method.

FIG. 1 illustrates an exemplary block diagram of a system 100 for on-device classification of fingertip motion patterns into gestures in real-time, in accordance with an embodiment of the present disclosure. The system 100 may also be referred as ‘a classification system’ or ‘a mobile communication device’ or ‘a video see through head mounted device’ and interchangeably used hereinafter. In an embodiment, the system 100 includes one or more processors 104, communication interface device(s) or input/output (I/O) interface(s) 106, and one or more data storage devices or memory 102 operatively coupled to the one or more processors 104. The one or more processors 104 may be one or more software processing modules and/or hardware processors. In an embodiment, the hardware processors can be implemented as one or more microprocessors, microcomputers, microcontrollers, digital signal processors, central processing units, state machines, logic circuitries, and/or any devices that manipulate signals based on operational instructions. Among other capabilities, the processor(s) is configured to fetch and execute computer-readable instructions stored in the memory. In an embodiment, the device 100 can be implemented in a variety of computing systems, such as laptop computers, notebooks, hand-held devices, workstations, mainframe computers, servers, a network cloud and the like.

The I/O interface device(s) 106 can include a variety of software and hardware interfaces, for example, a web interface, a graphical user interface, and the like and can facilitate multiple communications within a wide variety of networks N/W and protocol types, including wired networks, for example, LAN, cable, etc., and wireless networks, such as WLAN, cellular, or satellite. In an embodiment, the I/O interface device(s) can include one or more ports for connecting a number of devices to one another or to another server.

The memory 102 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. In an embodiment a database 108 can be stored in the memory 102, wherein the database 108 may comprise information, for example, a Red, Green, and Blue (RGB) input images captured from one or more computing devices (e.g., video see through head mounted devices), data pertaining to bounding boxes comprising hand candidates, down-scaled hand candidates, spatial location of fingertip detected from the down-scaled hand candidates, x and y coordinates derived from the spatial location of fingertip, and motion patterns of the fingertip being classified into one or more gestures, and the like. In an embodiment, the memory 102 may store (or stores) one or more technique(s) (e.g., feature extractor or feature detector—also referred as MobileNetV2, image processing technique(s) such as down-scaling), fingertip regression/regressor, Bi-Long Short Term Memory (Bi-LSTM) network and the like.), which when executed by the one or more hardware processors 104 perform the methodology described herein. The memory 102 further comprises (or may further comprise) information pertaining to input(s)/output(s) of each step performed by the systems and methods of the present disclosure. In an embodiment, the MobileNetV2 (feature extractor or feature detector), the image processing technique(s), the fingertip regression/regressor and the Bi-Long Short Term Memory (Bi-LSTM) network together coupled form a Cascaded Deep Learning Model (CDLM) which when executed by the one or more hardware processors 104 perform the methodology described herein.

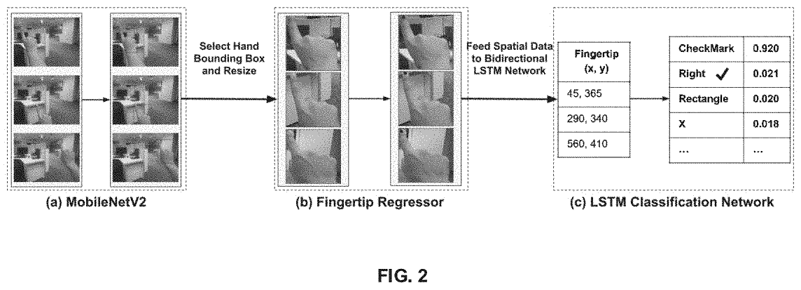

FIG. 2, with reference to FIG. 1, illustrates an exemplary block diagram of the system 100 for on-device classification of fingertip motion patterns into gestures in real-time, in accordance with an embodiment of the present disclosure, in accordance with an embodiment of the present disclosure. Alternatively, FIG. 2, illustrates an exemplary implementation of the system 100 for on-device classification of fingertip motion patterns into gestures in real-time, in accordance with an embodiment of the present disclosure, in accordance with an embodiment of the present disclosure. The architecture as depicted in FIG. 2 is configured to recognize a variety of hand gestures for frugal AR wearable devices with a monocular RGB camera input that requires only a limited amount of labelled classification data for classifying fingertip motion patterns into different hand gestures.

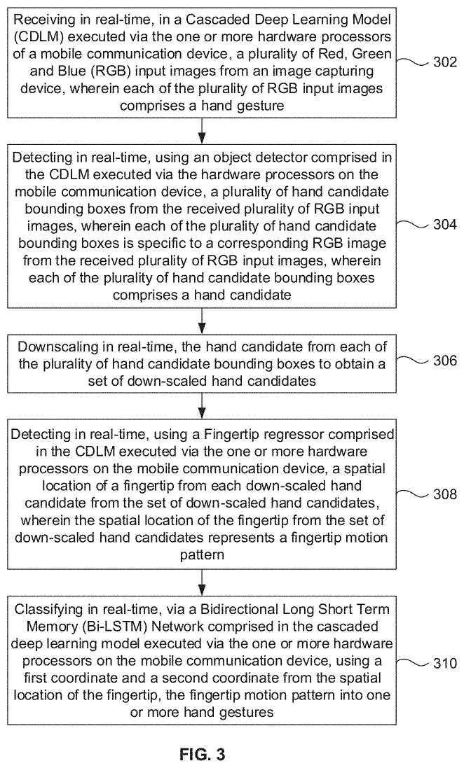

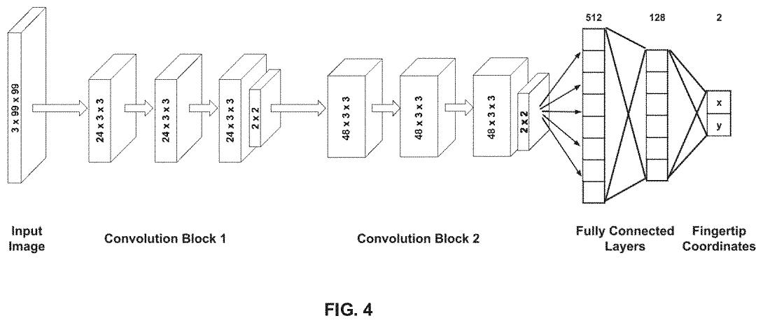

FIG. 3, with reference to FIGS. 1-2, illustrates an exemplary flow diagram of a method for on-device classification of fingertip motion patterns into gestures in real-time using the system 100 of FIG. 1 in accordance with an embodiment of the present disclosure. In an embodiment, the system(s) 100 comprises one or more data storage devices or the memory 102 operatively coupled to the one or more hardware processors 104 and is configured to store instructions for execution of steps of the method by the one or more processors 104. The steps of the method of the present disclosure will now be explained with reference to components of the system 100 of FIG. 1, block diagrams of FIGS. 2 and 4 and the flow diagram as depicted in FIG. 3. In an embodiment of the present disclosure, at step 302, the one or more hardware processors 104 receive in real-time, in a Cascaded Deep Learning Model (CDLM) executed via the one or more hardware processors of the mobile communication device 100, a plurality of Red, Green and Blue (RGB) input images from an image capturing device, wherein each of the plurality of RGB input images comprises a hand gesture. In other words, the mobile communication device 100 comprises the cascaded deep learning model having a feature extractor/an object detector (e.g., MobileNetV2 in the present disclosure) which takes single RGB image(s) as an input.

In an embodiment of the present disclosure, at step 304, the one or more hardware processors 104 detect in real-time, using an object detector comprised in the Cascaded Deep Learning Model (CDLM) executed on the mobile communication device 100, a plurality of hand candidate bounding boxes from the received plurality of RGB input images. In an embodiment, each of the plurality of hand candidate bounding boxes is specific to a corresponding RGB image from the received plurality of RGB input images and each hand candidate bounding box comprises a hand candidate. In other words, the MobileNetV2 outputs a hand candidate bounding box that comprises a hand candidate. Each of the hand candidate bounding boxes comprising the hand candidate depicts a pointing gesture pose to be utilized for classifying into the one or more hand gestures. FIG. 2 depicts a hand candidate output by an object detector of the cascaded deep learning model executed on the system 100 of FIG. 1.

MobileNetV2 is a streamlined architecture that uses depth-wise separable convolutions to build light weight deep neural networks. The depth-wise separable convolution factorizes a standard convolution into a depth-wise convolution and a 1×1 convolution also called a point-wise convolution thereby reducing the number of parameters in the network. It builds upon the ideas from MobileNetV1 (an earlier version of object detector), however, it incorporates two new features to the architecture: (i) linear bottlenecks between the layers, and (ii) skip connections between the bottlenecks. The bottlenecks encode the model's intermediate inputs and outputs while the inner layer encapsulates the model's ability to transform from lower-level concepts such as pixels to higher level descriptors such as image categories. Skip connections, similar to the traditional residual connections, enable faster training without any loss in accuracy.

In experiments conducted by the present disclosure to detect the hand candidate in RGB input images obtained from wearable devices, systems and methods of the present disclosure evaluate the MobileNetV2 feature extractor with conventional systems and methods/techniques (e.g., a convention technique 1—SSDLite—an object detection module. The Experiments and Results section highlights the results in comparison with prior art techniques with a pre-trained VGG-16 model consisting of 13 shared convolutional layers along with other compact models such as ZF (e.g., Zeiler and Fergus 2014) and VGG1024 (Chatfield et al. 2014) by modifying the last fully connected layer to detect hand class (pointing gesture pose).

Referring back to steps of FIG. 3, in an embodiment of the present disclosure, at step 306, the one or more hardware processors 104 downscale in real-time, the hand candidate from each of the plurality of hand candidate bounding boxes to obtain a set of down-scaled hand candidates. In other words, input images comprising hand candidates are first down-scaled to a specific resolution (e.g., 640×480 resolution in the present disclosure for a specific use case scenario) to reduce processing time without compromising on the quality of image features.

In an embodiment of the present disclosure, at step 308, the one or more hardware processors 104 detect in real-time, using a Fingertip regressor comprised in the Cascaded Deep Learning Model (CDLM) executed on the mobile communication device 100, a spatial location of a fingertip from each down-scaled hand candidate from the set of down-scaled hand candidates. In an embodiment, the spatial location of the fingertip from the set of down-scaled hand candidates represents a fingertip motion pattern. In other words, the detected hand candidates are then fed to the fingertip regressor as depicted in FIG. 2 which outputs the spatial location of the fingertip motion pattern (or also referred as fingertip).

In the present disclosure, the system 100 implements the fingertip regressor based on a Convolutional Neural Network (CNN) architecture to localise the (x, y) coordinates of the fingertip. The hand candidate detection (pointing gesture pose), discussed earlier, triggers the regression CNN for fingertip localisation. The hand candidate bounding box is first cropped and resized to 99×99 resolution before feeding it to the network depicted in FIG. 4. More specifically, FIG. 4, with reference to FIGS. 1 through 3, depicts a fingertip regressor architecture for fingertip localization as implemented by the system 100 of FIG. 1, in accordance with an example embodiment of the present disclosure.

The CNN architecture as implemented by the system 100 and present disclosure in FIG. 4 consists of two convolutional blocks each with three convolutional layers followed by a max-pooling layer. Finally, three fully connected layers are used to regress over the two coordinate values of fingertip point at the last layer. In the present disclosure, FIG. 4 depicts the fingertip regressor architecture for fingertip localisation. The input to the Bi-LSTM/LSTM classification network are 3×99×99 sized RGB images. Each of the 2 convolutional blocks have 3 convolutional layers each followed by a max-pooling layer. The 3 fully connected layers regress over fingertip spatial location. Since the aim is to determine continuous valued outputs corresponding to fingertip positions, Mean Squared Error (MSE) measure was used to compute loss at the last fully connected layer. The model was trained for robust localisation, and was compared with the architecture proposed by conventional technique(s).

In an embodiment of the present disclosure, at step 310, the one or more hardware processors 104 classify in real-time, via a Bidirectional Long Short Term Memory (Bi-LSTM) Network comprised in the Cascaded Deep Learning Model (CDLM) executed on the mobile communication device, using a first coordinate and a second coordinate from the spatial location of the fingertip, the fingertip motion pattern into one or more hand gestures. In other words, collection of these (e.g., spatial location—x and y coordinates of the fingertip motion patterns) are then fed it to the Bi-LSTM network for classifying the motion pattern into different gestures. More specifically, each fingertip motion pattern is classified into one or more hand gestures by applying a regression technique on the first coordinate (e.g., say ‘x’ coordinate) and the second coordinate (e.g., say ‘y’ coordinate) of the fingertip. In an embodiment, the ‘x’ and ‘y’ coordinates of the fingertip (or fingertip motion pattern) as depicted in FIG. 2 are 45 and 365 respectively for an action (e.g., gesture) being performed by a user. In another embodiment, the ‘x’ and ‘y’ coordinates of the fingertip as depicted in FIG. 2 are 290 and 340 respectively for another action being performed by the user. In yet another embodiment, the ‘x’ and ‘y’ coordinates of the fingertip as depicted in FIG. 2 are 560 and 410 respectively for yet another action being performed by the user. Additionally, in the section (c) of FIG. 2, that depicts the Bi-LSTM/LSTM classification network, the present disclosure also describes classification of fingertip detections on subsequent frames into different gestures (e.g., checkmark, right, rectangle, X (or delete), etc.). Further, each of these gestures that a particular fingertip motion pattern is classified into, the system 100 or the Bi-LSTM/LSTM classification network computes (or provides) a probability score (e.g., the probability score may be computed using known in the art technique(s)) that indicates the probability of a particular fingertip motion pattern to be identified/classified as a candidate gesture. For instance, for the ‘x’ and ‘y’ coordinates of the fingertip as 45 and 365 respectively, the Bi-LSTM/LSTM classification network has classified the fingertip motion pattern say as ‘checkmark gesture’ and has computed a probability score of 0.920 of that fingertip motion pattern of being the checkmark gesture, in one example embodiment. In other words, the probability score of 0.920 indicates that a particular fingertip motion pattern is a probable checkmark gesture based on its associated spatial location (or ‘x’ and ‘y’ coordinates) and is classified thereof, in one example embodiment. Similarly, probability scores are computed for other fingertip motion patterns for classification into other gestures as depicted in FIG. 4.

As described above, the fingertip localization network (or fingertip regressor) outputs the spatial locations of the fingertip (x, y), which are then fed as an input to the gesture classification network (or Bi-LSTM network). To reduce computational cost, input (x; y) coordinate is adjusted by the system 100 instead of the entire frame to the Bi-LSTM network thereby helping achieve real-time performance. It was observed through the experiments conducted by the present disclosure that Bi-LSTMs network as implemented by the system 100 performs better than LSTMs network for particular classification task since they process the sequence in both forward and reverse direction. The usage of LSTMs inherently means that the entire framework is also adaptable to videos and live feeds with variable length frame sequences. This is particularly important as the length of gestures depends on the user performing it and on the performance of the preceding two networks.

Conventional technique(s) have conducted a feasibility study for ranking the available modes of interaction for frugal Google® Cardboard set-up and reported that the frequent usage of magnetic trigger and conductive lever leads to wear and tear of the device and it scored poorly on usability. Hence, the present disclosure implements an automatic and implicit trigger to signify the starting and ending of a user input sequence. In the event of a positive pointing-finger hand detection on five consecutive frames, the framework is triggered to start recording the spatial location of the fingertip. In other words, the spatial location of the fingertip is detected based on a presence of a positive pointing-finger hand detection on a set of consecutive frames in the plurality of RGB input images, and this presence of the positive pointing-finger hand detection signifies a start of the hand gesture.

Similarly, the absence of any hand detections on (five) consecutive frames denotes the end of a gesture. In other words, an absence of a positive pointing-finger hand detection on a set of consecutive frames in the plurality of RGB input images signifies an end of the hand gesture. The recorded sequence was then fed as an input to the Bi-LSTM layer consisting of 30 units. The forward and backward activations were multiplied before being passed on to the next flattening layer that makes the data one-dimensional. It is then followed by a fully connected layer with 10 output scores that correspond to each of the 10 gestures. Since the task is to classify 10 gesture classes, a softmax activation function was used for interpreting the output scores as unnormalised log probabilities and squashes the output scores to be between 0 and 1 using the following equation:

$${σ ( s )}_{j} = \frac{{e}^{{s}_{j}}}{{\sum }_{k = 1}^{K} {e}^{{s}_{k}}} \qquad ( 1 )$$

where K denotes number of classes, s is a K×1 vector of scores, an input to softmax function, and j is an index varying from 1 to K. σ(s) is K×1 output vector denoting the posterior probabilities associated with each gesture. The cross-entropy loss has been used in training to update the model in network back-propagation.

Datasets

Present disclosure used the SCUT-Ego-Finger Dataset (e.g., refer Deepfinger: A cascade convolutional neuron network approach to finger key point detection in egocentric vision with mobile camera. In Systems, Man, and Cybernetics (SMC), 2015 IEEE International Conference on, 2944-2949. IEEE″—also referred as Huang et al. 2015) for training the hand detection and the fingertip localization modules depicted in FIG. 2. The dataset included 93729 frames of pointing hand gesture including hand candidate bounding boxes and index finger key-point coordinates.

(EgoGestAR) Dataset

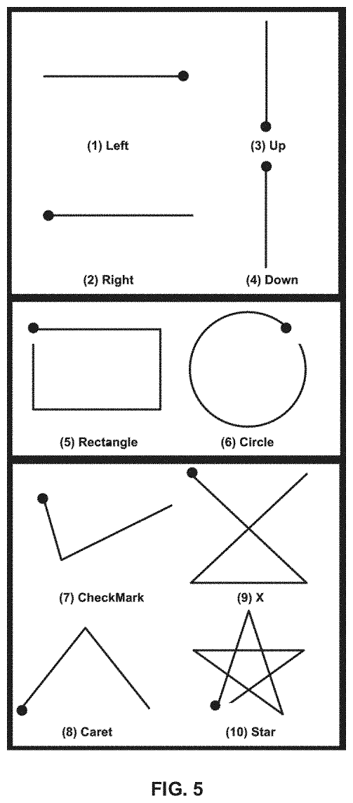

A major factor that has hampered the advent of deep learning in the task of recognizing temporal hand gestures is lack of available large-scale datasets to train neural networks on. Hence, to train and evaluate the gesture classification network, an egocentric vision gesture dataset for AR/MR wearables was used by the present disclosure. The dataset includes 10 gesture patterns. To introduce variability in the data, the dataset was collected with the help of 50 subjects chosen at random (from a laboratory) with ages spanning from 21 to 50. The average age of the subjects was 27.8 years. The dataset consisted of 2500 gesture patterns where each subject recorded 5 samples of each gesture. The gestures were recorded by mounting a tablet personal computer PC to a wall. The patterns drawn by the user's index finger on a touch interface application with position sensing region was stored. The data was captured at a resolution of 640×480. FIG. 5 describes the standard input sequences shown to the users before data collection. These gestures from the subjects (or users) were primarily divided into 3 categories for effective utilization in the present disclosure's context of data visualization in Mixed Reality (MR) applications. More specifically, FIG. 5, with reference to FIGS. 1 through 4, depicts gesture sequences shown to users before data collection, in accordance with an example embodiment of the present disclosure. The 3 categories shall not be construed as limiting the scope of the present disclosure, and are presented herein by way of examples and for better understanding of the embodiments described herein:
1. 4 swipe gesture patterns (Up, Down, Left, and Right) for navigating through graph visualisations/lists.
2. 2 gesture patterns (Rectangle and Circle) for Region of Interest (RoI) highlighting in user's FoV and for zoom-in and zoom-out operations.
3. 4 gesture patterns (CheckMark: Yes, Caret: No, X: Delete, Star: Bookmark) for answering contextual questions while interacting with applications such as industrial inspection (Ramakrishna et al. 2016).

Further, to test the entire framework as implemented by the systems and methods of the present disclosure, 240 videos were recorded by a random subset of the aforementioned subjects performing each gesture 22 times. Additional 20 videos of random hand movements were also recorded. The videos were recorded using a Android® device mounted on a Google® Cardboard. High quality videos were captured at a resolution of 640×480, and at 30 frames per second (FPS).

Experiments and Results

Since the framework implemented by the system 100 of the present disclosure comprises of three networks, performance of each of the networks was individually evaluated to arrive at the best combination of networks for the application as proposed by the present disclosure. An 8 core Intel® Core™ i7-6820HQ CPU, 32 GB memory and an Nvidia® Quadro M5000M GPU machine was utilized for experiments. A Snapdragon® 845 chipset smartphone was used which was interfaced with a server (wherever needed: to evaluate the method that runs on device) using a local network hosted on a Linksys EA6350 802.11ac compatible wireless router.

For all the experiments conducted by the present disclosure pertaining to hand detection and fingertip localisation, hand dataset as mentioned above was utilized. Out of the 24 subjects present in the dataset, 17 subjects' data was chosen for training with a validation split of 70:30, and 7 subjects' data (24; 155 images) for testing the networks.

Hand Detection

Table 1 reports percentage of mean Absolute Precision (mAP) and frame rate for hand candidate detection. More specifically, Table 1 depicts performance of various methods on the SCUT-Ego-Finger dataset for hand detection. mAP score, frame-rate and the model size are reported with the variation in IoU.

TABLE 1

| | On | mAP | mAP | Rate | Model |
|---|---|---|---|---|---|
| Model | Device | loU = 0.5 | loU = 0.7 | (FPS) | Size |
| F-RCNN VGG16 | No | 98.1 | 86.9 | 3 | 546 MB |
| (conventional | | | | | |
| model) | | | | | |
| F-RCNN | No | 96.8 | 86.7 | 10 | 350 MB |
| VGG1024 | | | | | |
| (conventional | | | | | |
| model) | | | | | |
| F-RCNN ZF | No | 97.3 | 89.2 | 12 | 236 MB |
| (conventional | | | | | |
| model) | | | | | |
| YOLOv2 | Yes | 93.9 | 78.2 | 2 | 202 MB |
| (conventional | | | | | |
| model) | | | | | |
| MobileNetV2 | Yes | 89.1 | 85.3 | 9 | 12 MB |
| (Present | | | | | |
| disclosure) | | | | | |

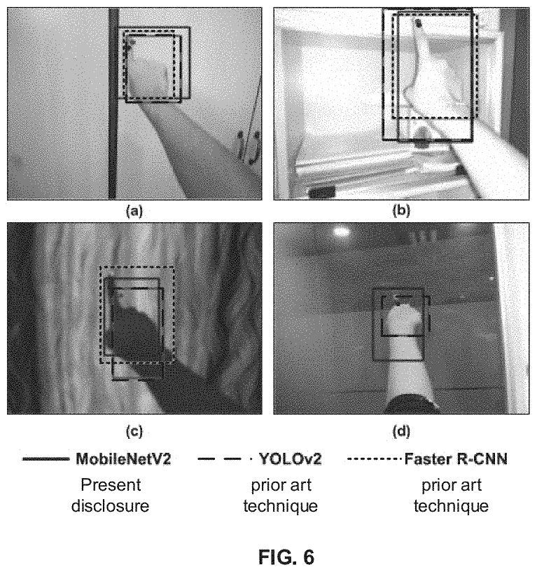

Even though MobileNetV2 achieved higher frame-rate compared to others, it produced high false positives hence resulted in poor classification performance. It is observed that prior art technique (e.g., YOLOv2—depicted by dashed line) can also run on-device although it outputs fewer frames as compared to MobileNetV2. At an Intersection over Union (IoU) of 0.5, YOLOv2 (depicted by dashed line) achieves 93.9% mAP on SCUT-Ego-Finger hand dataset whereas MobileNetV2 achieves 89.1% mAP. However, it was further observed that prior art technique (e.g., YOLOv2—depicted by dashed line) performs poorly when compared to MobileNetV2 in localizing the hand candidate at higher IoU that is required for including the fingertip. FIG. 6, with reference to FIGS. 1 through 5, depicts image comparison of present disclosure versus conventional approaches that indicate results of detectors (hand candidate bounding boxes) in different conditions such as poor illumination, blurry rendering, indoor and outdoor environments respectively, in accordance with an example embodiment of the present disclosure. It is noticed that even though both the detectors are unlikely to predict false positives in the background, prior art technique (e.g., YOLOv2—depicted by dashed line) makes more localisation errors proving MobileNetV2 to be a better fit for the use-case of the present disclosure.

It is further worth noticing that the model size for MobileNetV2 is significantly less than the rest of the models. It enables the present disclosure to port the model on mobile device and removes the framework's dependence on a remote server. This helps reduce latency introduced by the network and can enable wider reach of frugal devices for MR applications.

Fingertip Localization

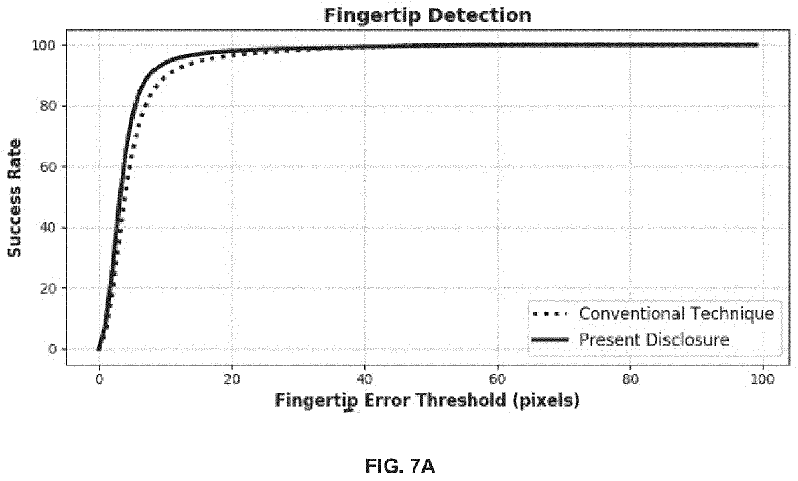

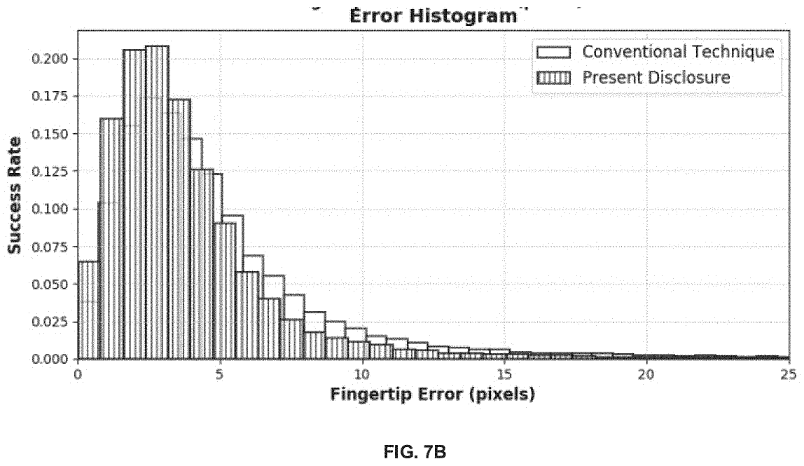

Present disclosure evaluated the model employed for fingertip localisation on the test set of 24,155 images. The 2×1 continuous-valued output corresponding to finger coordinate estimated at the last layer are been compared against ground truth values to compute rate of success with changing thresholds on the error (in pixels) and the resultant plot when compared to the network of conventional technique (e.g., refer A pointing gesture based egocentric interaction system: Dataset, approach and application. In Proceedings of the IEEE Conference on Computer Vision and Pattern Recognition Workshops, 16-23, by Huang, Y.; Liu, X.; Zhang, X.; and Jin, L. also referred as Huang et al. 2016) is shown in FIGS. 7A-7B. More specifically, FIGS. 7A-7B, with reference to FIGS. 1 through 6, illustrate a graphical representations depicting comparison of finger localization of the present disclosure versus with conventional technique(s), in accordance with an example embodiment of the present disclosure.

Adam optimiser with a learning rate of 0:001 has been used by the present disclosure. The model achieves 89.06% accuracy with an error tolerance of 10 pixels on an input image of 99×99 resolution. The mean absolute error is found to be 2.72 pixels for the approach of the present disclosure and is 3.59 pixels for the network proposed in conventional technique. It is evident from the graphical representation of FIGS. 7A-7B that the model implemented by the present disclosure achieves a higher success rate at any given error threshold (refer FIG. 7B). The fraction of images with low localization error is higher for the method of the present disclosure.

Gesture Classification

The present disclosure utilized proprietary dataset for training and testing of the gesture classification network. Classification with an LSTM network in the same training and testing setting was also tried/attempted as the Bi-LSTM. During training, 2000 gesture patterns of the training set were used. A total of 8,230 parameters of the network were trained with a batch size of 64 and validation split of 80:20. Adam optimiser with learning rate of 0:001 has been used. The networks were trained for 900 epochs which achieved validation accuracy of 95.17% and 96.5% for LSTM and Bi-LSTM respectively. LSTM and Bi-LSTM achieve classification accuracy of 92.5% and 94.3% respectively, outperforming the traditional approaches (or conventional technique(s)) that are being used for similar classification tasks. Comparison of the LSTM and Bi-LSTM approaches by the system are presented with conventional techniques' classification are presented in below Table 2.

TABLE 2

| Method | Precision | Recall | F1 Score |
|---|---|---|---|
| Conventional technique/research X | 0.741 | 0.76 | 0.734 |
| Conventional technique/research Y | 0.860 | 0.842 | 0.851 |
| LSTM | 0.975 | 0.920 | 0.947 |
| Bi-LSTM (Present disclosure) | 0.956 | 0.940 | 0.948 |

Conventional techniques/research include for example, Conventional technique/research X—‘Comparison of two real-time hand gesture recognition systems involving stereo cameras, depth camera, and inertial sensor. In SPIE Photonics Europe, 91390C-91390C. International Society for Optics and Photonics. by Liu, K.; Kehtarnavaz, N.; and Carlsohn, M. 2014’ and Conventional technique/research Y—‘Liblinear: A library for large linear classification. Journal of machine learning research 9(August):1871-1874, by Fan, R.-E.; Chang, K.-W.; Hsieh, C.-J.; Wang, X.-R.; and Lin, C.-J. 2008.—also referred as Fan et al.). More specifically Table 2 depicts performance of different classification methods on the proprietary dataset of the present disclosure. Average of precision and recall values for all classes is computed to get a single number.

Additionally, it was observed that the performance of traditional methods (or the conventional techniques as presented in Table 2) deteriorated significantly in the absence of sufficient data-points. Hence, they rely on complex interpolation techniques (leading to additional processing time and memory consumption) to give consistent results.

Framework Evaluation

Since the approach/method of the present disclosure is implemented or executed with a series of different networks, the overall classification accuracy in real-time may vary depending on the performance of each network used in the pipeline. Therefore, the entire framework was evaluated using 240 egocentric videos captured with a smartphone based Google® Cardboard head-mounted device. The MobileNetV2 model was used in the experiments conducted by the present disclosure as it achieved the best trade-off between accuracy and performance. Since the model can work independently on a smartphone using the TF-Lite engine, it removes the framework's dependence on a remote server and a quality network connection.

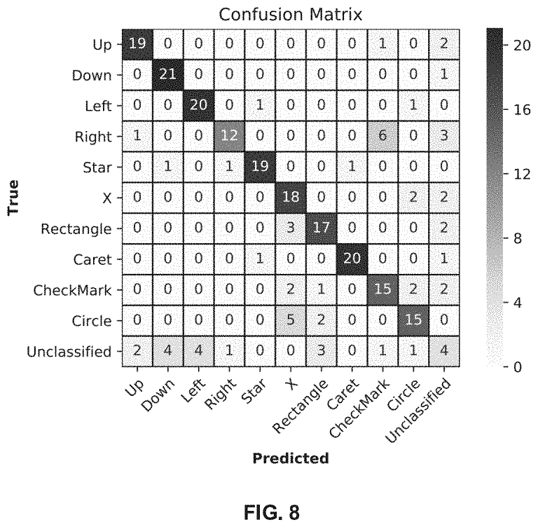

The framework achieved an overall accuracy of 80.00% on a dataset of 240 egocentric videos captured in FPV is as shown a matrix (also referred as confusion matrix) depicted in FIG. 8. More specifically, FIG. 8, with reference to FIGS. 1 through 7B, depicts an overall performance of the method of FIG. 3 on 240 egocentric videos captured using a smartphone based Google® Cardboard head-mounted device, in accordance with an example embodiment of the present disclosure. The gesture was detected when the predicted probability is more than 0.85. Accuracy of the method of present disclosure is 0.8 (excluding the unclassified class).

The MobileNetV2 network as implemented by the system 100 works at 9 FPS on 640×480 resolution videos, and the fingertip regressor as implemented by the system 100 is configured to deliver frame rates of up-to 166 FPS working at a resolution of 99×99. The gesture classification network as implemented by the system 100 processes a given stream of data in less than 100 ms. As a result, the average response time of the framework was found to be 0:12 s on a smartphone powered by a Snapdragon® 845 chip-set. The entire model had a (very small) memory footprint of 16.3 MB.

The systems and methods of the present disclosure were further compared with end-to-end Trained Gesture Classification Conventional Art Techniques (TGCCAT) and the results are depicted in Table 3. More specifically, Table 3 depicts analysis of gesture recognition accuracy and latency of various conventional models/techniques against the method of present disclosure. It is observed from below Table 3 that the method of present disclosure works on-device and effectively has the highest accuracy and the least response time.

TABLE 3

| Method | Accuracy | Time taken | On Device |
|---|---|---|---|
| TGCCAT 1 | 32.27 | 0.76 | No |
| TGCCAT 2 | 58.18 | 0.69 | No |
| TGCCAT 3 | 66.36 | 1.19 | No |
| Present | 80.00 | 0.12 | Yes |
| disclosure | | | |

Conventional technique TGCCAT 1 proposed a network that works with differential image input to convolutional LSTMs to capture the body parts' motion involved in the gestures performed in second-person view. Even after fine-tuning the model on the video dataset of the present disclosure, it produced an accuracy of only 32.14% as the data of the present disclosure involved a dynamic background and no static reference to the camera.

Conventional technique TGCCAT 2 uses 2D CNNs to extract features from each frame. These frame wise features were then encoded as a temporally deep video descriptor which are fed to an LSTM network for classification. Similarly, a 3D CNNs approach (Conventional technique TGCCAT 3) uses 3D CNNs to extract features directly from video clips. Table 3 shows that both of these conventional methods do not perform well. A plausible intuitive reason for this is that the network may be learning noisy and bad features while training. Other conventional techniques such as for example, attention based video classification also performed poorly owing to the high inter-class similarity. Since features from only a small portion of the entire frame is required, that is, the fingertip, such attention models appear redundant since the fingertip location is already known.

Further existing/conventional technique(s) and systems implement using virtual buttons that appear in stereo view by placing the fingertip over them which is like mid-air fingertip based user interaction. Such conventional techniques employ a Faster-Region Convolutional Neural Network (RCNN) for classification of gestures and also implement networked GPU server(s) which are powerful and are not fully utilized, and are further cost expensive. Conventional techniques and systems also rely on the presence of high-bandwidth, low latency network connection between the device and the abovementioned server. Unlike the conventional systems and methods/technique(s) as mentioned above, embodiments of the present disclosure provide systems and methods for an On-Device pointing finger based gestural interface for devices (e.g., Smartphones) and Video See-Through Headmounts (VSTH) or video see-through head mounted devices. By, using the video see through head mounted devices by the present disclosure makes the system 100 of the present disclosure a light weight gestural interface for classification of pointing-hand gestures being performed by the user purely on device (specifically smartphones and video see through head-mounts). Further, the system 100 of the present disclosure implements and executes a memory and compute efficient MobileNetv2 architecture to localise hand candidate(s) and a different fingertip regressor framework to track the user's fingertip and Bi-directional Long Short-Term Memory (Bi-LSTM) model to classify the gestures. Advantages of such an architecture or Cascaded Deep Learning Model (CDLM) as implemented by the system 100 of the present disclosure, is that the system 100 does not rely on the presence of a powerful and networked GPU server. Since all computation(s) is/are carried on the device itself, the system 100 can be deployed in a network-less environment and further opens new avenues in terms of applications in remote locations.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

It is to be understood that the scope of the protection is extended to such a program and in addition to a computer-readable means having a message therein; such computer-readable storage means contain program-code means for implementation of one or more steps of the method, when the program runs on a server or mobile device or any suitable programmable device. The hardware device can be any kind of device which can be programmed including e.g. any kind of computer like a server or a personal computer, or the like, or any combination thereof. The device may also include means which could be e.g. hardware means like e.g. an application-specific integrated circuit (ASIC), a field-programmable gate array (FPGA), or a combination of hardware and software means, e.g. an ASIC and an FPGA, or at least one microprocessor and at least one memory with software modules located therein. Thus, the means can include both hardware means and software means. The method embodiments described herein could be implemented in hardware and software. The device may also include software means. Alternatively, the embodiments may be implemented on different hardware devices, e.g. using a plurality of CPUs.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer readable medium can be any apparatus that can comprise, store, communicate, propagate, or transport the program for use by or in connection with the instruction execution system, apparatus, or device.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope of disclosed embodiments being indicated by the following claims.

What is claimed is:

1. A processor implemented method for an on-device classification of fingertip motion patterns into gestures in real-time, the method comprising:
receiving in real-time, in a Cascaded Deep Learning Model (CDLM) executed via the one or more hardware processors of a mobile communication device (302), a plurality of Red, Green and Blue (RGB) input images from an image capturing device, wherein each of the plurality of RGB input images comprises a hand gesture;
detecting in real-time, using an object detector comprised in the Cascaded Deep Learning Model (CDLM) executed via the one or more hardware processors on the mobile communication device, a plurality of hand candidate bounding boxes from the received plurality of RGB input images (304), wherein each of the plurality of hand candidate bounding boxes is specific to a corresponding RGB image from the received plurality of RGB input images, wherein each of the plurality of hand candidate bounding boxes comprises a hand candidate;
downscaling in real-time, the hand candidate from each of the plurality of hand candidate bounding boxes to obtain a set of down-scaled hand candidates (306);
detecting in real-time, using a Fingertip regressor comprised in the Cascaded Deep Learning Model (CDLM) executed via the one or more hardware processors on the mobile communication device, a spatial location of a fingertip from each down-scaled hand candidate from the set of down-scaled hand candidates (308), wherein the spatial location of the fingertip from the set of down-scaled hand candidates represents a fingertip motion pattern; and
classifying in real-time, via a Bidirectional Long Short Term Memory (Bi-LSTM) Network comprised in the Cascaded Deep Learning Model (CDLM) executed via the one or more hardware processors on the mobile communication device, using a first coordinate and a second coordinate from the spatial location of the fingertip, the fingertip motion pattern into one or more hand gestures (310).

2. The processor implemented method of claim 1, wherein each of the hand candidate bounding boxes comprising the hand candidate depicts a pointing gesture pose to be utilized for classifying into the one or more hand gestures.

3. The processor implemented method of claim 1, wherein the step of classifying the fingertip motion pattern into one or more hand gestures comprises applying a regression technique on the first coordinate and the second coordinate of the fingertip.

4. The processor implemented method of claim 1, wherein the spatial location of the fingertip is detected based on a presence of a positive pointing-finger hand detection on a set of consecutive frames in the plurality of RGB input images, and wherein the presence of the positive pointing-finger hand detection is indicative of a start of the hand gesture.

5. The processor implemented method of claim 1, wherein an absence of a positive pointing-finger hand detection on a set of consecutive frames in the plurality of RGB input images is indicative of an end of the hand gesture.

6. A system (100) for classification of fingertip motion patterns into gestures in real-time, the system comprising:
a memory (102) storing instructions;
one or more communication interfaces (106); and
one or more hardware processors (104) coupled to the memory (102) via the one or more communication interfaces (106), wherein the one or more hardware processors (104) are configured by the instructions to:
receive in real-time, in a Cascaded Deep Learning Model (CDLM) executed via the one or more hardware processors of the system, a plurality of Red, Green and Blue (RGB) input images from an image capturing device, wherein each of the plurality of RGB input images comprises a hand gesture;
detect in real-time, using an object detector comprised in the Cascaded Deep Learning Model (CDLM) executed via the one or more hardware processors on the system, a plurality of hand candidate bounding boxes from the received plurality of RGB input images, wherein each of the plurality of hand candidate bounding boxes is specific to a corresponding RGB image from the received plurality of RGB input images, wherein each of the plurality of hand candidate bounding boxes comprises a hand candidate;
downscale in real-time, the hand candidate from each of the plurality of hand candidate bounding boxes to obtain a set of down-scaled hand candidates;
detect in real-time, using a Fingertip regressor comprised in the Cascaded Deep Learning Model (CDLM) executed via the one or more hardware processors on the system, a spatial location of a fingertip from each down-scaled hand candidate from the set of down-scaled hand candidates, wherein the spatial location of the fingertip from the set of down-scaled hand candidates represents a fingertip motion pattern; and
classify in real-time, via a Bidirectional Long Short Term Memory (Bi-LSTM) Network comprised in the Cascaded Deep Learning Model (CDLM) executed via the one or more hardware processors on the system, using a first coordinate and a second coordinate from the spatial location of the fingertip, the fingertip motion pattern into one or more hand gestures.

7. The system of claim 6, wherein each of the hand candidate bounding boxes comprising the hand candidate depicts a pointing gesture pose to be utilized for classifying into the one or more hand gestures.

8. The system of claim 6, wherein the fingertip motion pattern is classified into one or more hand gestures by applying a regression technique on the first coordinate and the second coordinate of the fingertip.

9. The system of claim 6, wherein the spatial location of the fingertip is detected based on a presence of a positive pointing-finger hand detection on a set of consecutive frames in the plurality of RGB input images, and wherein the presence of the positive pointing-finger hand detection is indicative of a start of the hand gesture.

10. The system of claim 6, wherein an absence of a positive pointing-finger hand detection on a set of consecutive frames in the plurality of RGB input images is indicative of an end of the hand gesture.

11. One or more non-transitory machine readable information storage mediums comprising one or more instructions which when executed by one or more hardware processors cause an on-device classification of fingertip motion patterns into gestures in real-time by:
receiving in real-time, in a Cascaded Deep Learning Model (CDLM) executed via the one or more hardware processors of a mobile communication device, a plurality of Red, Green and Blue (RGB) input images from an image capturing device, wherein each of the plurality of RGB input images comprises a hand gesture;
detecting in real-time, using an object detector comprised in the Cascaded Deep Learning Model (CDLM) executed via the one or more hardware processors on the mobile communication device, a plurality of hand candidate bounding boxes from the received plurality of RGB input images, wherein each of the plurality of hand candidate bounding boxes is specific to a corresponding RGB image from the received plurality of RGB input images, wherein each of the plurality of hand candidate bounding boxes comprises a hand candidate;
downscaling in real-time, the hand candidate from each of the plurality of hand candidate bounding boxes to obtain a set of down-scaled hand candidates;
detecting in real-time, using a Fingertip regressor comprised in the Cascaded Deep Learning Model (CDLM) executed via the one or more hardware processors on the mobile communication device, a spatial location of a fingertip from each down-scaled hand candidate from the set of down-scaled hand candidates, wherein the spatial location of the fingertip from the set of down-scaled hand candidates represents a fingertip motion pattern; and
classifying in real-time, via a Bidirectional Long Short Term Memory (Bi-LSTM) Network comprised in the Cascaded Deep Learning Model (CDLM) executed via the one or more hardware processors on the mobile communication device, using a first coordinate and a second coordinate from the spatial location of the fingertip, the fingertip motion pattern into one or more hand gestures.

12. The one or more non-transitory machine readable information storage mediums of claim 11, wherein each of the hand candidate bounding boxes comprising the hand candidate depicts a pointing gesture pose to be utilized for classifying into the one or more hand gestures.

13. The one or more non-transitory machine readable information storage mediums of claim 11, wherein the step of classifying the fingertip motion pattern into one or more hand gestures comprises applying a regression technique on the first coordinate and the second coordinate of the fingertip.

14. The one or more non-transitory machine readable information storage mediums of claim 11, wherein the spatial location of the fingertip is detected based on a presence of a positive pointing-finger hand detection on a set of consecutive frames in the plurality of RGB input images, and wherein the presence of the positive pointing-finger hand detection is indicative of a start of the hand gesture.

15. The one or more non-transitory machine readable information storage mediums of claim 11, wherein an absence of a positive pointing-finger hand detection on a set of consecutive frames in the plurality of RGB input images is indicative of an end of the hand gesture.
